(19) United States
(12) Patent Application Publication
(10) Pub. No.: US 2009/0223365 A1
(43) Pub. Date: Sep. 10, 2009

(54) Treatment of water containing dissolved gases

(76) Inventor: Philip Michael Morkel, Gauteng Province (ZA)

Correspondence Address: KNOBBE MARTENS OLSON & BEAR LLP, 2040 MAIN STREET, FOURTEENTH FLOOR, IRVINE, CA, 92614, US

(21) Appl. No.: 10/557,570

(22) PCT Filed: May 14, 2004
(86) PCT No.: PCT/IB04/01559

§ 371 Date: Nov. 14, 2008

(30) Foreign Application Priority Data
May 21, 2003 (ZA) 2002/9467

(51) Int. Cl. B01D 19/00

(52) U.S. Cl. 95/30; 96/155; 96/175; 95/241

(57) ABSTRACT

This invention relates to a method and apparatus for the treatment of water containing a percentage of dissolved gases to recover at least some of the gases, such as methane gas, from the water. The apparatus comprises a feed pipe having an inlet and an outlet in flow communication with a separation chamber. The chamber has a gas outlet and a water outlet for discharging separated gases and water respectively. A means for stimulating the formation of bubbles, such as an ultrasound transducer, is associated with the feed pipe. The invention also relates to a method of treating water containing dissolved gases including positioning a tube having an inlet and an outlet, the inlet being positioned below the outlet in the water and using at least one device to stimulate formation of gas bubbles in water in the tube to cause an upward flow of water in the tube.

### FIELD OF THE INVENTION

This invention relates to a method and apparatus for the treatment of water containing a percentage of dissolved gases in order to recover at least some of the gases from the water.

### BACKGROUND TO THE INVENTION

Lake Kivu in central Africa is a deep lake (approximately 400-450 m) situated close to a geographical fault line. This causes heating and the accumulation of carbon dioxide in the waters of the lake. As there is stratification and very little circulation of the waters the water containing dissolved carbon dioxide remains close to the bottom of the lake where the methanogen bacteria transforms the carbon dioxide into methane. The ratio of carbon dioxide to methane in the waters near the bottom of the lake is approximately 5:1.

It has long been realised that the dissolved methane represents a potentially valuable energy resource. Also, it has been suggested that there is a long-term risk of a major catastrophe occurring, resulting in the loss of life of tens of thousands of people in the vicinity, if the methane gas is not removed from the water. It is supposed that volcanic activity can journey water up and result in methane being released to the surrounding atmosphere where it could easily explode, but will simultaneously release a large cloud of asphyxiating gas.

A separation plant exists which essentially has a pipe bringing water from the bottom to the surface where the gas bubbles out naturally and is so simply separated from the water. Bringing the water to the surface is fairly easily achieved as a natural hydraulic siphon is formed in the pipe at steady-state. Separation of the carbon dioxide from the desired methane is a little more problematical and it is this separation process, usually through water washing, which negatively affects the economic viability of the separation plant.

It is recognised that the separation process would be more efficient at depth due to the increased pressure which results in a more preferable ratio of methane to carbon dioxide being released and better washing efficiency. However, no economic process has yet been devised to achieve this, particularly as the natural siphon or gas lift loses efficiency with depth.

### OBJECT OF THE INVENTION

It is an object of this invention to provide a method and apparatus for the treatment of water which will at least partially alleviate some of the abovementioned problems.

### SUMMARY OF THE INVENTION

In accordance with this invention there is provided apparatus for the separation of dissolved gases from a body of water wherein such gases are concentrated in the lower part of the body comprising a feed pipe having an inlet and an outlet in flow communication with a separation chamber, the separation chamber having a gas outlet and a water outlet for discharging separated gases and water respectively and wherein means for stimulating the formation of bubbles is associated with the feed pipe.

Further features of the invention provide for the means for stimulating bubble formation to include an electrical or mechanical device and, in the case where the means includes an electrical device, for the device to include one or a plurality of ultrasonic transducer and, where it includes a plurality of ultrasonic transducers, for the ultrasonic transducers to be spaced partly along the length of the feed pipe; for the feed pipe to be substantially upright and to be curved through 180° adjacent its outlet; and for the separation chamber to be configured to be located below the surface of the body.

Still further features of the invention provide for the gas outlet to feed into a scrubber unit; and for the water outlet to discharge at a location removed from the inlet of the feed pipe.

The invention also provides for a method of treating water containing dissolved gases which includes positioning a tube having an inlet and an outlet with the inlet positioned below the outlet in the water and using at least one electrical or mechanical device to stimulate the formation of gas bubbles in water in the tube to cause an upward flow of water in the tube.

Further features of the invention provide for the device which stimulates bubble formation to be an ultrasonic transducer; preferably for there to be a plurality of such bubble stimulating devices which are spaced apart along at least part of the length of the tube; and for the tube with the at least one device therein to be located below the surface of a body of water.

The invention further provides for a method of separating dissolved gases from a body of water wherein such gases are concentrated in the lower part of the body which includes locating a feed pipe having an inlet in the body with the inlet near the bottom of the body and an outlet in flow communication with a separation chamber located below the surface of the body with the inlet positioned below the outlet; stimulating bubble formation in the feed pipe to cause water and gas to flow upwards into the separation chamber; and allowing the water in the separation chamber to be displaced out of the separation chamber through a water outlet and gas in the separation chamber to be displaced out of the separation chamber through a gas outlet.

Further features of the invention provide for the bubble formation to be stimulated by at least one electrical or mechanical device and for the device to preferably be an ultrasonic transducer.

### BRIEF DESCRIPTION OF THE DRAWINGS

Two embodiments of the invention will be described, by way of example only, with reference to the drawings in which:

FIG. 1 is a sketch of a first embodiment of apparatus for the separation of dissolved gases located in a body of water; and

FIG. 2 is a sketch of a second embodiment of such apparatus.

### DETAILED DESCRIPTION OF THE DRAWINGS

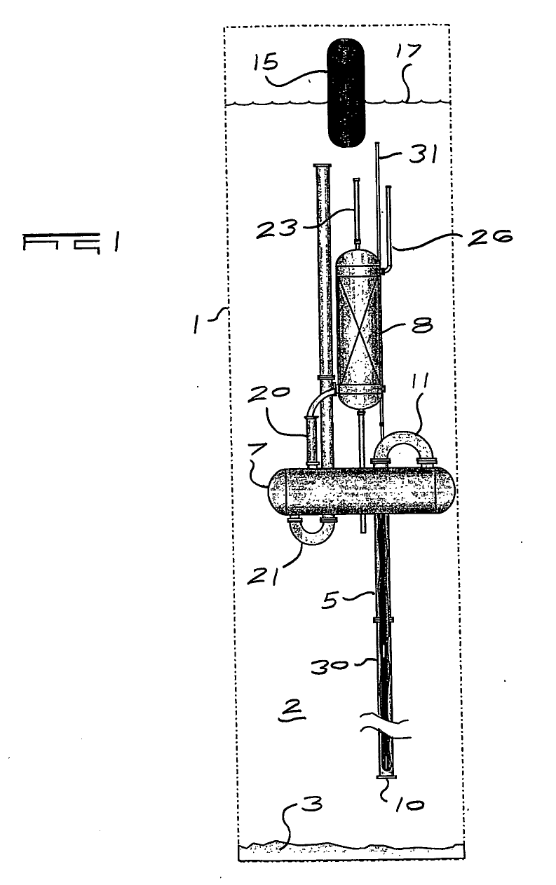

As shown in FIG. 1, apparatus (1) for the separation of dissolved gases from a body of water (2), in this embodiment a lake, having a high proportion of such gases in the water adjacent the bottom (3) thereof includes a feed pipe (5), a separation chamber (7) and a scrubber (8). The gases dissolved in the water include methane and carbon dioxide.

The inlet (10) of the feed pipe (5) is located deeper than 275 m, near the bottom (3) of the body (2) with the outlet (11) of the feed pipe (5) in flow communication with an inlet to the separation chamber (7). The feed pipe (5) has a U-shaped bend adjacent the outlet (11) so that the outlet (11) feeds downwardly into the separation chamber (7).

The separation chamber (7) is suspended from a floating buoy (15) at a depth of between 15 and 60 m, in this instance about 60 m, below the surface (17) of the body (2). A gas outlet (20) in the separation chamber (7) feeds into the scrubber (8) while a fluid outlet (21) feeds into the body (2) some distance above and away from the apparatus (1).

The scrubber (8) has a gas outlet (23) which feeds into a pressure control station (not shown) on a platform (not shown) which feeds a gas supply pipeline (not shown) to shore. The platform also contains a wash water supply (26) for the scrubber (8), pumps and start-up pumps (not shown).

A string of ultrasonic transducers (30) is suspended within the feed pipe (5) near the separation chamber (7) and operated by cables (31) from the buoy (15).

In use, water fills the feed pipe (5) but the pressure at the depth of the apparatus (1) prevents spontaneous release of the gases from the water. Gas-laden water is drawn up the feed pipe (5) into the separation chamber (7) to commence start-up. Operation of the ultrasonic transducers (30) stimulates the formation of bubbles, which in turn cause a reduction of pressure near the outlet (11). This encourages the release of gas from the water as well as a natural hydraulic siphon to be formed in the feed pipe (5). Water and gas are thus fed into the separation chamber (7) where separation of the gas and water takes place. Release of the gas from the water causes a gas buildup in the separation chamber (7) which displaces the water in the separation chamber (7) out the outlet (21) and the gas out the outlet (20) into the scrubber (8). In the scrubber (8) much of the carbon dioxide is removed from the gas by water washing, leaving relatively high quality methane for further processing or use.

Operation of the apparatus at up to 60 m depth increases the ratio of released methane to carbon dioxide by up to six times over a similar apparatus operating at atmospheric pressure. Also, the washing efficiency of the scrubber (8) is increased more than ten times by operation thereof at 60 m depth, relative to atmospheric scrubbing.

However, operation of the apparatus is only practically viable using means to stimulate bubble formation in the feed pipe. In particular, such means should have a low energy and maintenance requirement. Ultrasonic transducers are considered to be ideally suited to this task, but the process can be operated similarly by using high-pressure water injection through a whistle, or similar nozzle, which causes ultrasonic waves through high shear.

Ultrasonic stimulation causes the device to yield large numbers of small bubbles that remain in suspension in the stream of water. The bubble size should optimally be about 1 micron diameter and typically less than 5 microns.

It will be appreciated, however, that many other embodiments of apparatus exist which fall within the scope of the invention especially as regards the configuration thereof and the means for stimulating bubble formation. For example, the apparatus may have a number of separation chambers and scrubber units. Importantly, any suitable means for stimulating bubble formation can be used.

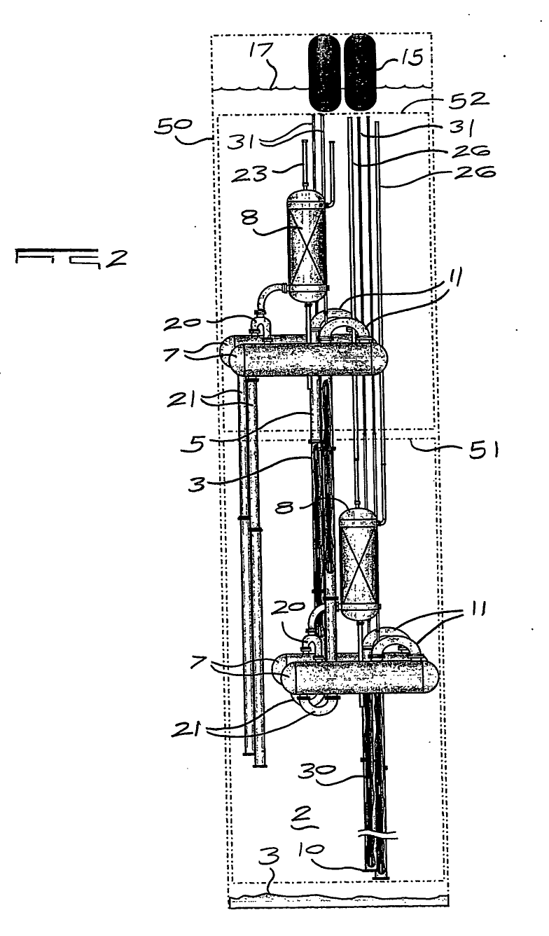

As shown in FIG. 2, where like features are indicated by like numerals, the apparatus (50) could have two stages (51, 52), with each stage (51, 52) having a pair of separation chambers (7) operating in parallel and feeding into a scrubber unit (8). The separation chambers (7) of the first stage (51) are located at a depth of between 50 and 60 m while the separation chambers (7) of the second stage (52) are located at a depth of between 15 and 20 m. The scrubber (8) of the first stage (51) feeds gas to the platform (15) as described with reference to the embodiment in FIG. 1. However, the fluid outlet (21) of each separation chamber (7) of the first stage (51) feeds into the respective separation chambers (7) of the second stage (52) with a string of ultrasonic transducers (30) in each pipe intermediate in the separation chambers (7) of the stages (51, 52).

The second stage (52) operates in identical fashion to the apparatus in the embodiment described with reference to FIG. 1. Hence, its operation need not be described in any further detail.

It is envisaged that the second stage will increase methane recovery by up to 45% over a single stage whilst it will also provide sufficient driving force to keep the process operating without the need to vent water from a separation chamber to the surface. This proves not only environmentally friendly in that it avoids the emission of greenhouse gases to the atmosphere but also beneficial in that the resource is better preserved. The two-stage process has been calculated to yield an 83% recovery of methane from the water whilst only 2% of the energy produced from the recovered methane will be needed to run the apparatus.

A highly efficient and environmentally friendly apparatus is thus provided by the invention.

1. Apparatus for the separation of dissolved gases from a body of water wherein such gases are concentrated in the lower part of the body comprising a feed pipe having an inlet and an outlet in flow communication with a separation chamber, the separation chamber having a gas outlet and a water outlet for discharging separated gases and water respectively and wherein means for stimulating the formation of bubbles is associated with the feed pipe.

2. Apparatus as claimed in claim 1 wherein the means for stimulating bubble formation includes an electrical device.

3. Apparatus as claimed in claim 2 wherein the electrical device includes at least one ultrasonic transducer.

4. Apparatus as claimed in claim 2 wherein the electrical device includes a plurality of ultrasonic transducers.

5. Apparatus as claimed in claim 4 wherein the ultrasonic transducers are spaced partly along the length of the feed pipe.

6. Apparatus as claimed in claim 1 wherein the means for stimulating bubble formation includes a mechanical device.

7. Apparatus as claimed in claim 1 wherein the feed pipe is substantially upright and curved through 180° adjacent its outlet.

8. Apparatus as claimed in claim 1 in which the separation chamber is configured to be located below the surface of the body.

9. Apparatus as claimed in claim 1 wherein the gas outlet feeds into a scrubber unit.

10. Apparatus as claimed in claim 1 in which the water outlet discharges at a location removed from the inlet of the feed pipe.

11. A method of treating water containing dissolved gases which includes positioning a tube having an inlet and an outlet with the inlet positioned below the outlet in the water and using at least one device to stimulate the formation of gas bubbles in water in the tube to cause an upward flow of water in the tube.

12. A method as claimed in claim 11 which includes stimulating bubble formation using at least one electrical device.

13. A method as claimed in claim 12 wherein the electrical device is an ultrasonic transducer.

14. A method as claimed in claim 11 which includes stimulating bubble formation using at least one mechanical device.

15. A method as claimed in claim 11 wherein the at least one device comprises a plurality of devices spaced apart along at least part of the length of the tube.

16. A method of separating dissolved gases from a body of water wherein such gases are concentrated in the lower part of the body which includes locating a feed pipe having an inlet in the body with the inlet near the bottom of the body and an outlet in flow communication with a separation chamber located below the surface of the body with the inlet positioned below the outlet, stimulating bubble formation in the feed pipe to cause water and gas to flow upwards into the separation chamber, and allowing the water in the separation chamber to be displaced out of the separation chamber through a water outlet and gas in the separation chamber to be displaced out of the separation chamber through a gas outlet.

17. A method as claimed in claim 16 which includes stimulating bubble formation using at least one electrical device.

18. A method as claimed in claim 17 wherein the electric device is an ultrasonic transducer.

19. A method as claimed in claim 16 which includes stimulating bubble formation using at least one mechanical device.

20. (canceled)

21. (canceled)
